(19) United States
(12) Patent Application Publication
(10) Pub. No.: US 2024/0334329 A1
(43) Pub. Date: Oct. 3, 2024

(54) DESIGN ON LOW-POWER RADIO LAYER OF DUAL RADIO FOR B5G/6G

(71) Applicant: MEDIATEK INC., Hsinchu (TW)

(72) Inventors: Yi-Ju Liao, Hsinchu (TW); Din-Hwa Huang, Hsinchu (TW); Chien-Chun CHENG, Hsinchu (TW); Wei-De Wu, Hsinchu (TW)

(21) Appl. No.: 18/616,358

(22) Filed: Mar. 26, 2024

Related U.S. Application Data
(60) Provisional application No. 63/493,331, filed on Mar. 31, 2023.

(51) Int. Cl. H04W 52/02; H04W 68/02

(52) U.S. Cl. CPC H04W 52/0229; H04W 68/02

(57) ABSTRACT

In an aspect of the disclosure, a method, a computer-readable medium, and an apparatus are provided. The apparatus may be a user equipment (UE). The UE receives, from a base station, a low-power radio layer (LPRL) synchronization signal on an LPRL for synchronization and measurement. The UE communicates, on the LPRL, wake-up information or paging information with the base station for subsequent communications on a high-performance radio layer (HPRL). The UE detects, on the HPRL, a signal transmitted from the base station.

### CROSS-REFERENCE TO RELATED APPLICATION(S)

This application claims the benefits of U.S. Provisional Application Ser. No. 63/493,331, entitled “LOW-POWER RADIO LAYER OF DUAL RADIO FOR B5G/6G” and filed on Mar. 31, 2023, which is expressly incorporated by reference herein in its entirety.

### BACKGROUND

### Field

The present disclosure relates generally to communication systems, and more particularly, to techniques of utilizing low-power radio layer of dual radio on user equipment and base stations.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. Other telecommunication standard examples may be 5G Advanced, beyond 5G, pre-6G, 6G, etc. Some technologies associated with 5G Advanced, beyond 5G, pre-6G, 6G may build on 4G LTE or 5G NR. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The UE receives, from a base station, a low-power radio layer (LPRL) synchronization signal on an LPRL for synchronization and measurement. The UE communicates, on the LPRL, wake-up information or paging information with the base station for subsequent communications on a high-performance radio layer (HPRL). The UE detects, on the HPRL, a signal transmitted from the base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIGS. 7(A)-7(D) illustrates communications between a UE and a base station.

FIG. 8 is a diagram illustrating communications between the base station and UE in an idle/inactive mode.

FIG. 9 is a diagram illustrating communications between the base station and the UE during initial cell search (power on).

FIG. 10 is a diagram illustrating communications between the base station and the UE during connected mode.

FIG. 11 is a flow chart of a method for wireless communication utilizing an LPRL and an HPRL.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

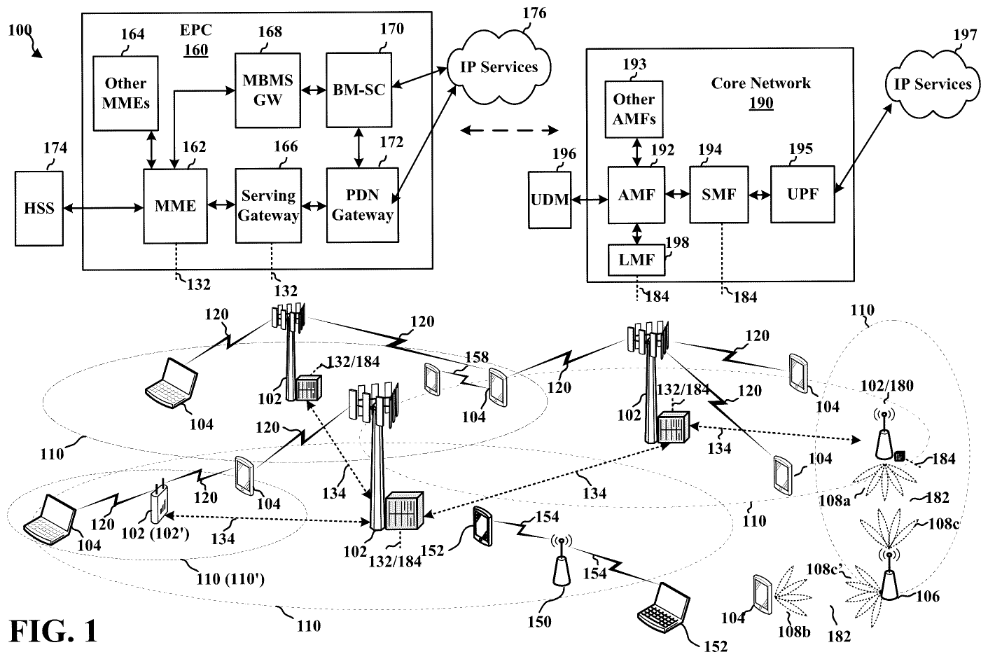

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHZ, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The base station 106 may perform beamformed signals transmission with the UE 104 in one or more beam directions (108c, 108c′). The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

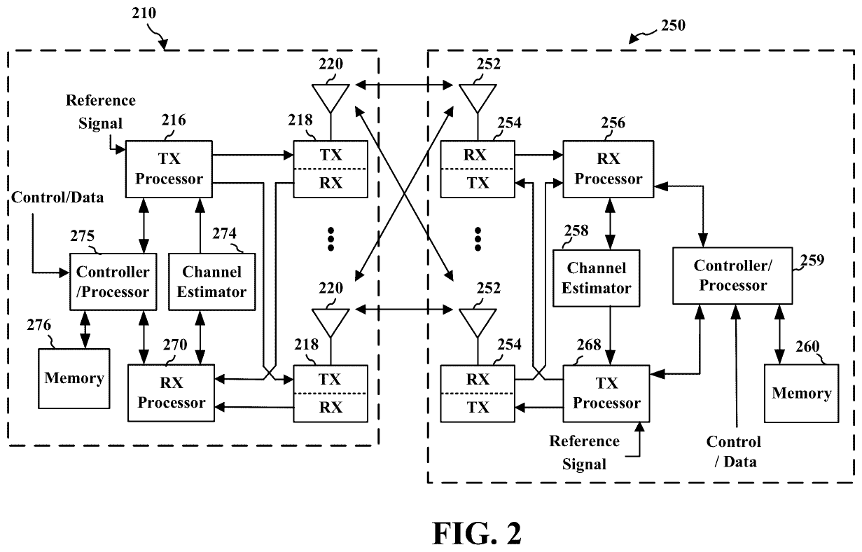

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

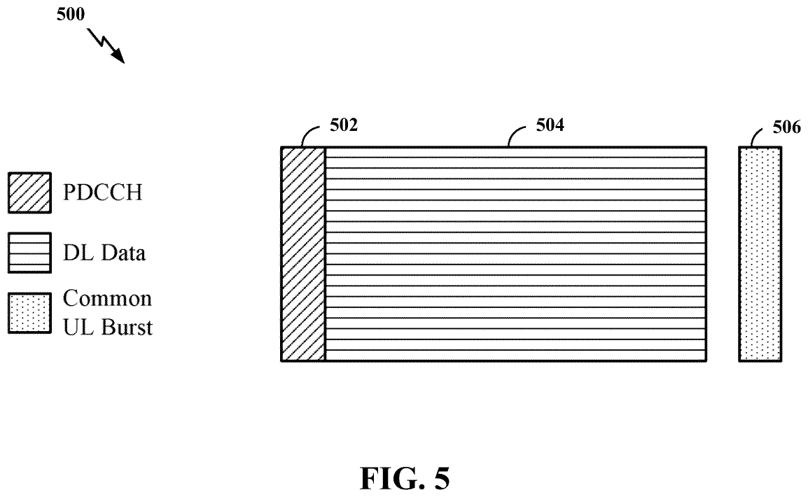

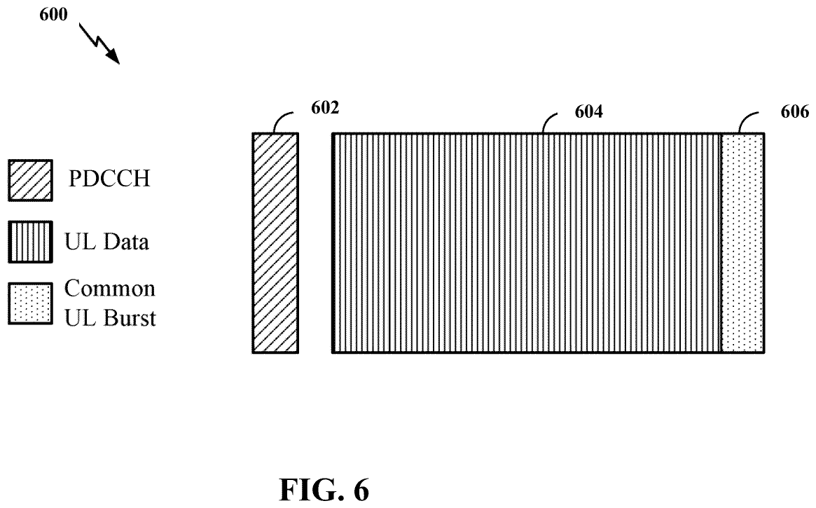

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUS). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

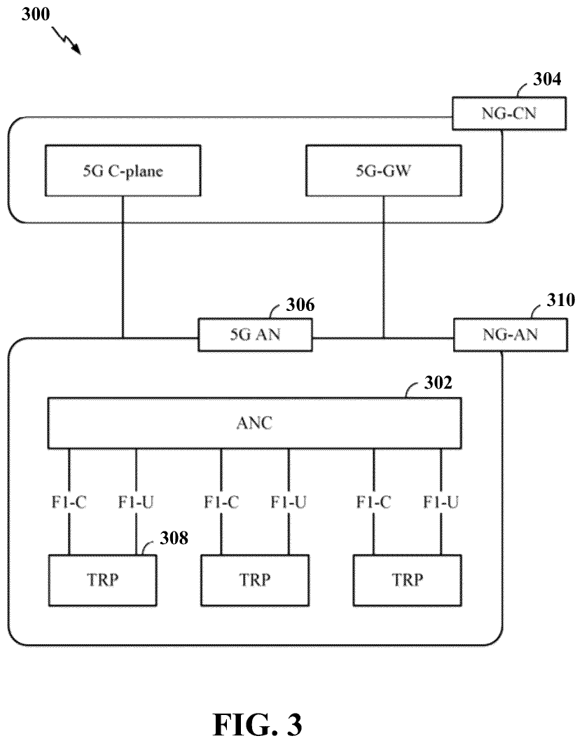

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

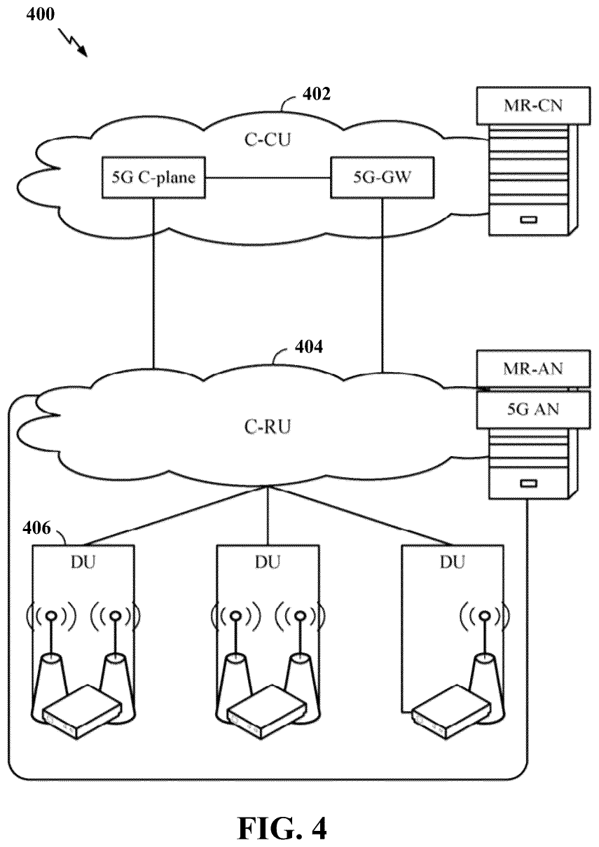

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

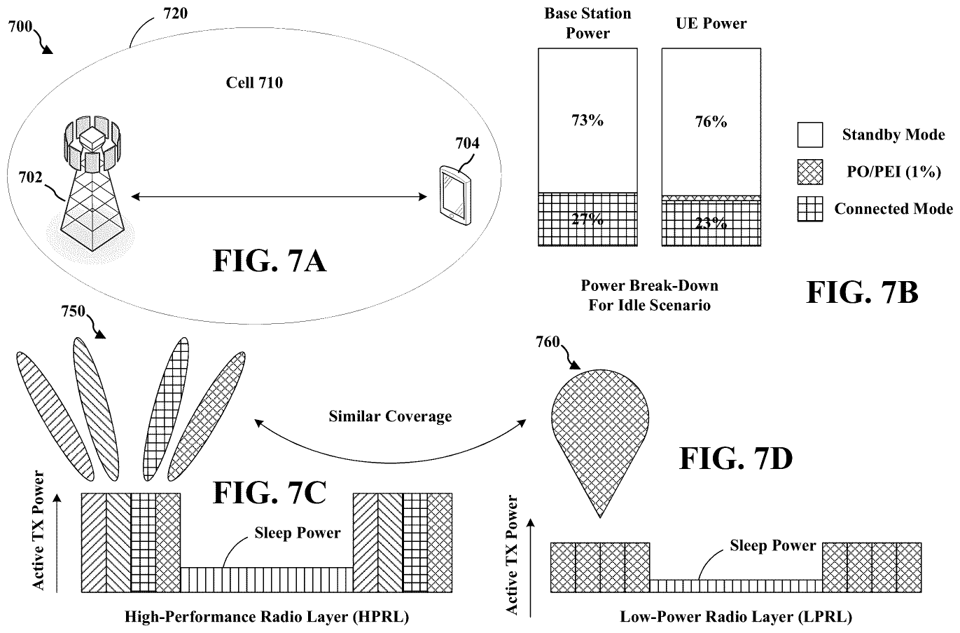

FIGS. 7(A)-7(D) illustrates communications between a UE 704 and a base station 702. In this example, the UE 704 may be connected to a cell 710 that has a coverage 720.

In certain configurations, the base station 702 and the UE 704 both employ regular power radio layer. The base station 702 and the UE 704 may operate in an idle scenario or a data transmission and reception scenario. In the idle scenario, the UE 704 is in an RRC idle or inactive mode and is not actively transmitting or receiving data with the base station 702. The UE 704 performs essential operations to maintain a connection with the cell 710, such as synchronization and measurement, by receiving signals like the synchronization signal block (SSB) from the base station 702. In contrast, the data transmission and reception scenario refers to when the UE 704 is in an RRC connected mode and is actively sending or receiving data with the base station 702.

The power breakdown for the base station 702 and the UE 704 in the idle scenario is illustrated in FIG. 7(B). For the base station side, the power consumption mainly comes from periodically transmitting the SSB (e.g., 27% of the power) and the sleep power overhead (e.g., 73% of the power). To reduce the energy consumption of the base station 702, the power for transmitting the SSB and the sleep power should be decreased.

For the UE side, the main power consumption comes from receiving the SSB (e.g., 23% of the power) for synchronization and measurement, as well as the sleep and wake-up energy (e.g., 76% of the power). Further, 1% is consumed by paging occasions (PO) and paging event indications (PEI). To reduce the UE's power consumption, the energy consumption for receiving the SSB and performing synchronization and measurement should be lowered. Additionally, the sleep power and wake-up energy overhead should be reduced.

In certain configurations, to minimize the energy consumption of the base station 702 and the UE 704 during idle operation, the base station 702 and the UE 704 may implement a low-power radio layer (LPRL). The LPRL is designed to handle all the essential operations, such as synchronization and measurement, while maintaining the link between the base station 702 and the UE 704 with minimal energy consumption. Additionally, the base station 702 and the UE 704 also implement a high-performance radio layer.

During idle operation, the base station 702 and the UE 704 primarily utilize the low-power radio layer (LPRL) for essential tasks such as synchronization, measurement, and maintaining the link between them. The LPRL is designed to minimize energy consumption by using simpler signal structures and allowing the UE 704 to employ a less complex receiver.

However, in certain situations, the high-performance radio layer (HPRL) may be used for on-demand reference signals (RS) to facilitate fine synchronization and the transmission of Master Information Block (MIB) or System Information Block (SIB). These on-demand RS are necessary when the UE 704 requires more precise synchronization or needs to receive larger payloads, such as those in the SIB.

The motivation behind the LPRL stems from the need to improve energy efficiency and achieve carbon neutrality in future wireless communication systems, such as Beyond 5G (B5G) or 6G networks. Regular radio layers, designed for high performance, consume significant power even during idle scenarios, where minimal data transmission occurs. This is primarily due to the complex signal processing and protocol requirements needed to maintain synchronization, perform cell measurements, and handle paging operations.

In contrast to the regular power radio layer (RPRL) used in NR systems, which can be considered a single radio system with complex signal processing such as beamforming, protocol for control, and encoding data, the LPRL employs a different approach. The base station 702 uses a wide beam with fewer antenna elements to transmit a simpler signal structure, such as a sequence-based signal. This allows the UE 704 to use a simpler receiver, which may utilize techniques such as repetition to achieve similar signal coverage while consuming less power during each active period.

Although the receiving time may be longer with the LPRL, the active power consumption is lower for each instance. This approach enables the UE 704 to save power while maintaining the essential operations and link with the base station 702.

By introducing the LPRL, the base station 702 and the UE 704 can minimize their energy consumption during idle operation, as the LPRL is designed to handle the most essential operations while keeping the active power consumption low.

The low-power radio layer (LPRL) is designed to minimize the energy consumption of the base station 702 and the UE 704 during idle operation. The LPRL is primarily for transmitting periodic common reference signals (RS) for coarse synchronization, measurement, and wake-up/paging indication.

The LPRL enables power savings for the base station 702 by lowering active power consumption due to the use of a smaller number of antenna elements and by lowering sleep power consumption.

Similarly, the LPRL enables power savings for the UE 704 through utilizing a tiny-area receiver to reduce sleep/wake-up energy overhead and utilizing an ultra-low complexity receiver that accommodates all necessary idle mode operations, thereby reducing active power consumption.

The LPRL achieves these power savings by employing a simpler signal structure and processing compared to the regular power radio layer (RPRL). The base station 702 transmits common reference signals using a wide beam with fewer antenna elements, while the UE 704 utilizes a low-complexity receiver that can perform essential operations such as synchronization, measurement, and paging indication reception.

In addition to transmitting data, the base station 702 may also transmit reference signals (RS) for fine synchronization or signals that require more complex coding, such as system information blocks (SIBs) with larger payloads. These signals are transmitted on-demand using the high-performance radio layer (HPRL).

The base station 702 can employ different strategies for transmitting on-demand signals, depending on the needs of the UE 704 and the network conditions. Two possible options are:

If there is a need, such as a request from one or multiple UEs, the base station 702 starts transmitting the signal or channel in a broadcast manner (e.g., periodically). This mode is suitable for scenarios where the need for fine synchronization or MIB/SIB transmission is general and not specific to any UE.

If there is a need, such as a request from one or multiple UEs, the base station 702 transmits the signal or channel by request (e.g., aperiodically or UE-specific or group-UE-specific) when the number of UEs and/or the paging rate is low. The base station 702 starts transmitting the signal or channel in a broadcast manner (e.g., periodically) when the number of UEs and/or the paging rate is high.

When the base station 702 transmits on-demand signals, the UE 704 switches to the high-power state to receive these signals. This typically indicates that the UE 704 wants to enter the connected mode for data reception, which requires more precise reference signals for fine synchronization.

The base station 702 can adjust its transmission strategy based on the number of UEs requesting on-demand signals. For example, if only one UE sends a request, the base station 702 can transmit UE-specific RS. However, when the number of requesting UEs reaches a certain threshold, the base station 702 can switch to a broadcast RS to serve multiple UEs simultaneously.

FIG. 7(C) illustrates beamforming, coverage and power consumption of the high-performance radio layer. FIG. 7(D) illustrates beamforming, coverage and power consumption of the low-power radio layer.

The LPRL generates a single, wide beam 760. The HPRL formed multiple beams 750, each representing different transmission paths or channels. The LPRL is designed to provide similar coverage to the HPRL. This means that despite using less complex signal structures and potentially fewer antenna elements, the LPRL can maintain a connection over a comparable area to that of the HPRL.

In some scenarios, the sleep power and active transmission power of the low-power radio layer are lower than those of the high-performance radio layer. This shows the energy efficiency of the LPRL, particularly when the UE and the base station are in an idle state and not actively engaged in data transmission or reception. In contrast, the HPRL is responsible for more complex operations, such as fine synchronization and the transmission of Master Information Blocks (MIB) and System Information Blocks (SIB), which require higher power consumption. The LPRL can be used for maintaining essential operations with minimal energy usage, while the HPRL can be activated as needed for data-intensive tasks.

The base station 702 and the UE 704, can switch between the LPRL and HPRL depending on the operation scenario. For example, during idle or inactive modes, the UE 704 can rely on the LPRL to perform necessary synchronization and measurement while conserving power. Conversely, when active data transmission or reception is required, the UE 704 can utilize the HPRL to handle the increased data throughput and signal processing demands.

The low-power radio layer (LPRL) and the high-performance radio layer (HPRL) can operate simultaneously in certain scenarios, depending on the UE's state and the required operations. The LPRL is primarily designed to maintain essential operations, such as synchronization and measurement, while minimizing energy consumption. On the other hand, the HPRL is utilized for more complex tasks, such as data transmission and reception, which require higher processing power and energy consumption.

In idle mode, the UE 704 may only need to maintain a connection with the base station 702 and perform basic measurements. In this case, the UE 704 can rely solely on the LPRL, as it does not need to receive or transmit data. However, when the UE 704 needs to receive data or prepare to enter connected mode, it must activate the HPRL to handle the increased complexity of the incoming signals, such as those required for fine synchronization.

During connected mode, the UE 704 may need to perform measurements while simultaneously receiving or transmitting data. In this scenario, both the LPRL and HPRL can operate concurrently. The LPRL can be used to receive signals for measurement purposes, while the HPRL is employed for data decoding and other complex operations.

From the base station 702 perspective, the choice between LPRL and HPRL can be seen as an adaptation in the spatial domain, such as switching between different antenna configurations. For the UE 704, the distinction lies in the type of receiver used for each layer. The LPRL may utilize a smaller, less complex receiver designed for low-power operations, while the HPRL may incorporate a more advanced receiver capable of handling complex coding schemes and beamforming techniques.

The LPRL and HPRL are not always mutually exclusive and can coexist depending on the UE's state and the required operations. The base station 702 and the UE 704 can dynamically switch between the two layers or utilize them simultaneously to optimize power consumption and maintain the necessary functionality. During idle or inactive modes, the LPRL is primarily used to conserve energy while maintaining essential link operations. However, when the UE 704 requires data transmission or reception, or when more precise synchronization is needed, it transitions to using the HPRL. The transition to HPRL is necessitated when the payload size or the need for fine synchronization exceeds the capabilities of the LPRL.

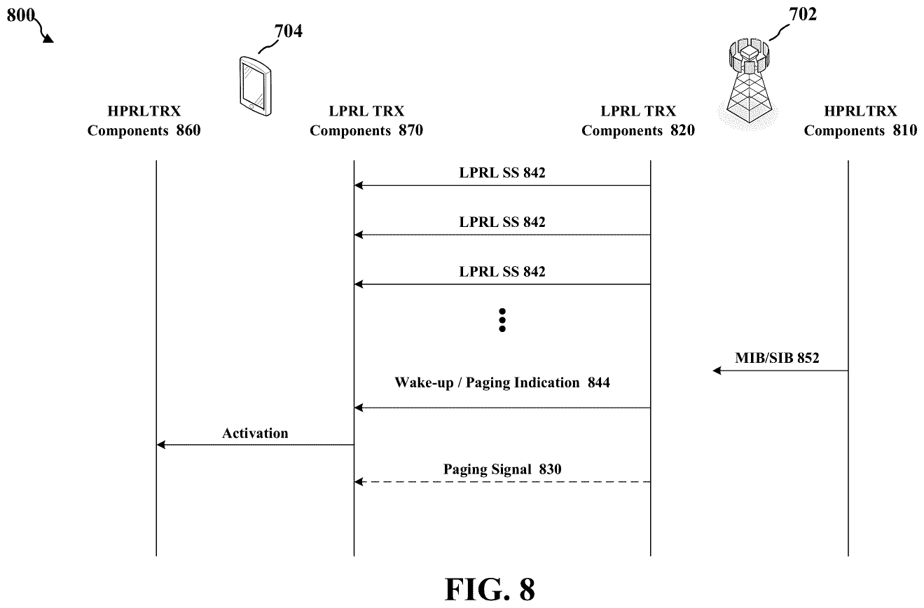

FIG. 8 is a diagram 800 illustrating communications between the base station 702 and the UE 704 in the idle/inactive mode. The base station 702 has HPRL transmit-receive (TRX) components 810 and LPRL TRX components 820. The UE 704 has HPRL TRX components 860 and LPRL TRX components 870. In this example, both the base station 702 and the UE 704 are operating in idle mode. The UE 704 may have a computing structure similar to that of the UE 250. The base station 702 may have a computing structure similar to that of the base station 210.

In the idle mode, the UE 704 receives the LPRL synchronization signal 842 from the LPRL TRX components 820 of the base station 702 for coarse synchronization and cell measurement. The LPRL synchronization signal 842 is periodically transmitted by the base station 702 and is designed to maintain a connection between the base station 702 and the UE 704 while minimizing energy consumption.

The LPRL synchronization signal 842 may be used for timing synchronization for the LPRL, idle mode wake-up indication or paging signal detection, cell ID detection, Reference Signal Received Power (RSRP) measurement, etc.

The LPRL synchronization signal 842 is a signal similar to the Primary Synchronization Signal (PSS) and Secondary Synchronization Signal (SSS) in generations of cellular networks. However, the signal structure of the LPRL synchronization signal 842 may be different and may require techniques such repetition to achieve better coverage. Further, the LPRL synchronization signal 842 may also carry a message.

The base station 702 may also transmit signal 844 containing a wake-up indication or a paging indication/message, depending on the design. If the UE 704 receives a wake-up indication, it means that the UE 704 should expect to receive a paging signal 830 containing a paging message subsequently. On the other hand, if the message directly carries a paging message, it effectively serves as a UE-specific paging mechanism.

To facilitate necessary measurements, the UE 704 may perform cell ID detection and RSRP measurement using the LPRL synchronization signal 842. When the base station 702 wants to wake up the UE 704, it sends a wake-up indication or a paging indication. Upon successfully detecting the wake-up indication or paging indication, the UE 704 activates its HPRL TRX components 860 to prepare for further communication with the base station 702. This allows the UE 704 to enter connected mode or receive more complex signals, such as those required for fine synchronization or data transmission.

The base station 702 periodically transmits the LPRL synchronization signal 842 to maintain the connection with the UE 704 and to facilitate necessary measurements. When needed, the base station 702 may also transmit the Master Information Block (MIB) and System Information Blocks (SIBs) 852 using the HPRL TRX components 810.

For the UE 704 in idle or inactive mode, the base station 702 indicates at least one of the following information, through the paging signal 830 (or paging channel), via the LPRL: paging related information; an indication for system information update (e.g., 1 bit); a notification for Earthquake and Tsunami Warning System (ETWS) and/or Commercial Mobile Alert System (CMAS) (e.g., 2 bits).

The signal (e.g., the paging signal 830) containing the above information is using either a sequence-based format or a payload format. When the payload format is used, N CRC bits, where N>1, are attached after the payload to achieve a feasible false alarm rate. For example, setting N=8 can achieve a 1% false alarm rate.

Regarding the paging related information, at least one of the following options is adopted:
Option 1: a Wake-up indication (e.g., 1 bit for the UE 704 or a group of UEs)
After receiving the wake-up indication, the UE 704 further receives a paging message (e.g., paging PDCCH/PDSCH) transmitted by either the low-power radio layer or the high-performance radio layer.
Option 2: a Paging message (e.g., UE ID)
After receiving and detecting/decoding the paging message, the UE 704 further performs the Random Access Channel (RACH) procedure for entering RRC connected mode. In one example, the bit number for the paging message is 48 bits and 40 bits for the UE 704 when it is in RRC idle and inactive mode, respectively.
In another example, the paging message (e.g., UE ID) for one or a group of UEs is distributed in multiple signals/channels transmitted on different time and/or frequency resources. The UE 704 receives and detects/decodes multiple signals/channels to determine whether it is being paged.

The paging signal 830 essentially integrates the paging indication or paging channel into the low-power radio layer. As described supra, the signal structure can be either sequence-based or payload-based. When using the payload format, CRC bits are added to ensure a desired false alarm rate.

The paging related information can be either a wake-up indication or a paging message, depending on the device type. For the wake-up indication (Option 1), the UE 704 receives the indication from the low-power radio layer and may then wake up its high-performance receiver to receive the actual paging message. For the paging message (Option 2), the paging message directly carries the UE ID. When the UE 704 detects its UE ID, it knows it is being paged and proceeds to perform the RACH procedure to enter the connected mode.

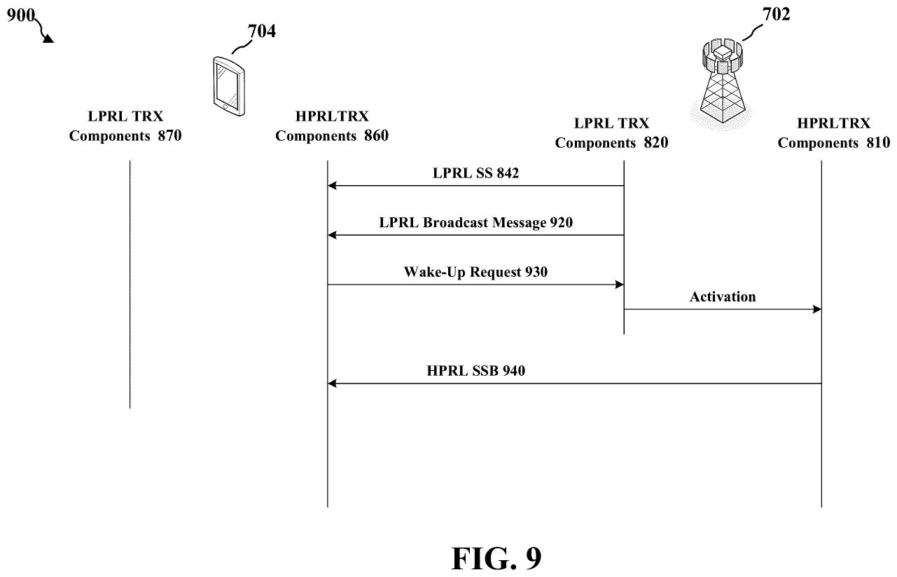

FIG. 9 is a diagram 900 illustrating communications between the base station 702 and the UE 704 during initial cell search (power on). During the initial cell search, when the UE 704 is powered on, it assumes that the LPRL synchronization signal 842 from the LPRL is present. However, the UE 704 does not assume that the HPRL SSB 940 (including RS for fine synchronization and MIB) from the HPRL is present in the beginning. The UE 704 also assumes that the content of the LPRL broadcast message 920 (i.e., payload) from the LPRL is scenario-dependent.

The HPRL SSB 940 is a signal transmitted on the high-performance radio layer, which can include RS, MIB, and/or SIB.

In the initial cell search process, the LPRL TRX components 820 of the base station 702 continuously broadcast the LPRL synchronization signal 842 and the LPRL broadcast message 920. The UE 704 performs cell search procedures, which include finding the frequency and timing, as well as detecting and measuring the cell ID.

After conducting extensive cell measurements, the UE 704 sends a wake-up request 930 to the cell 710 with the best signal quality. If the base station 702 successfully detects the wake-up request 930, it starts transmitting on-demand RS, such as HPRL SSBs 940, using the HPRL TRX components 810 on the high-performance radio layer.

The UE 704 then utilizes the on-demand RS (e.g., the HPRL SSB 940) to perform more precise synchronization and receive MIB or SIB. This process can include time/frequency synchronization for HPRL (e.g., TRS-like or CSI-RS-like signal is generated based on the detected cell ID to estimate time/frequency offset), MIB acquisition, SIB acquisition.

While operating on the low-power radio layer, the UE 704 receives the LPRL synchronization signal 842 and the LPRL broadcast message 920. This step also provides Automatic Gain Control (AGC), a timing reference, a potential frequency reference of the HPRL SSB 940, and other information related to the position of the on-demand RS.

The UE 704 obtains this information, which helps the high-performance radio layer know how to proceed. It is important to note that the UE 704 can use either the HPRL TRX components 860 (high-capability receiver) or the LPRL TRX components 870 (low-capability receiver) to perform these tasks, depending on the UE implementation.

When the UE 704 is powered on, it is in an awake state and uses the HPRL TRX components 860 to quickly connect to the network. The signal transmitted by the LPRL TRX components 820 of the base station 702 can be processed by both the HPRL TRX components 860 and the LPRL TRX components 870 of the UE 704. However, the signal transmitted by the HPRL TRX components 810 of the base station 702 can only be processed by the HPRL TRX components 860 of the UE 704, as the LPRL TRX components 870 have limited capability and cannot process the more complex signals from the high-performance radio layer.

For the UE 704 receiving or transmitting signals/channels on the low-power radio layer, the UE 704 receives a synchronization signal for time and/or frequency synchronization on the low-power radio layer. This synchronization signal, known as the LPRL synchronization signal 842, serves a similar purpose to the Primary Synchronization Signal (PSS) and Secondary Synchronization Signal (SSS) in cellular networks. However, the signal structure of the LPRL synchronization signal 842 may be different and may require techniques such as repetition to achieve better coverage.

The main purpose of the UE 704 receiving the LPRL synchronization signal 842 is to perform synchronization, which includes timing and frequency synchronization. There are several options for the information carried by the LPRL synchronization signal 842, which can be considered analogous to the PSS and SSS:
Option 1: No information is carried on the synchronization signal
In this case, the LPRL synchronization signal 842 is purely used for synchronization purposes and does not carry any additional information, such as the Cell ID.
Option 2: Partial Cell ID is carried on the synchronization signal
If the full Cell ID has a length of M bits (e.g., M=10), then the length of the partial Cell ID carried by the LPRL synchronization signal 842 is 1≤X<M bits. In this case, the UE 704 determines the full Cell ID by combining the information from the LPRL synchronization signal 842 and the LPRL broadcast message 920.
When partial Cell ID is carried, the UE 704 measures the link quality (e.g., Reference Signal Received Power (RSRP)) based on either the LPRL synchronization signal 842 only or the LPRL synchronization signal 842 and the LPRL broadcast message 920.
Option 3: Full Cell ID is carried on the synchronization signal
In this case, the UE 704 measures the link quality (e.g., RSRP) based on the LPRL synchronization signal 842.

The different options for carrying Cell ID information on the LPRL synchronization signal 842 are due to the trade-off between signal complexity and detection performance. As mentioned earlier, the low-power radio layer is designed to have a simpler signal structure compared to the high-performance radio layer. Carrying the full Cell ID, which may require around 10 bits, can increase the complexity of the LPRL synchronization signal 842 and may require more detection attempts by the UE 704.

On the other hand, not carrying any Cell ID information or carrying only partial Cell ID information can simplify the LPRL synchronization signal 842 structure but may require additional information from the LPRL broadcast message 920 to determine the full Cell ID. The choice of which option to adopt depends on the specific design requirements and the trade-off between signal complexity and detection performance.

The base station 702 periodically transmits a broadcast message, denoted as the LPRL broadcast message 920, via the low-power radio layer. This message carries essential information for the UE 704 to maintain a connection with the cell 710 and perform necessary operations. The LPRL broadcast message 920 includes at least one of the following information:
Partial or full Cell ID: If the LPRL synchronization signal 842 does not carry the full Cell ID, the LPRL broadcast message 920 will include the remaining bits of the Cell ID. For example, if the full Cell ID requires 10 bits and the LPRL synchronization signal 842 carries 3 bits, the LPRL broadcast message 920 will carry the remaining 7 bits.
Sleeping cell indication (SCI): A 1-bit indicator that informs the UE 704 whether the base station 702 is currently transmitting signals on the high-performance radio layer, such as the MIB/SIB 852 or fine synchronization signals. If the SCI indicates that the base station 702 is not transmitting on the high-performance radio layer (i.e., the cell 710 is in a “sleeping” state), the UE 704 will need to send the wake-up request 930 to prompt the base station 702 to start transmitting on the high-performance radio layer. Conversely, if the SCI indicates that the base station 702 is already transmitting on the high-performance radio layer, the UE 704 can directly receive those signals without sending the wake-up request 930.
System information update: A 1-bit indicator that notifies the UE 704 about any updates to the system information.
ETWS and/or CMAS notification: A 2-bit indicator for Earthquake and Tsunami Warning System (ETWS) and/or Commercial Mobile Alert System (CMAS) notifications. The inclusion of these indicators in the LPRL broadcast message 920 or the paging message is a design choice.
Base station wake-up signal relevant information: This information is necessary for the UE 704 to send the wake-up request 930 to the base station 702. It includes the monitoring location, frequency resources, and signal format (e.g., sequence root) of the wake-up signal, allowing the base station 702 to correctly detect and respond to the wake-up request 930.
Frequency reference of the HPRL SSB 940: To receive the MIB/SIB 852, the UE 704 needs to know the frequency reference of the HPRL SSB 940. In one example, this is provided as a Global Synchronization Channel Number (GSCN) offset. The frequency of the HPRL SSB 940 is derived by adding the GSCN offset to a reference frequency (ref_A), which is dependent on the frequency range.
Time reference of the HPRL SSB 940: This information helps the UE 704 to locate the HPRL SSB 940 in time. In one example, it is provided as a time offset to the closest HPRL SSB 940, with a granularity of one slot.
Power offset between the LPRL synchronization signal 842 and the HPRL SSB 940: As the low-power radio layer and high-performance radio layer may have different power levels, this information is necessary for the UE 704 to perform Automatic Gain Control (AGC) tuning when switching between the two layers.
Subcarrier spacing (SCS) of the HPRL SSB 940: The SCS of the HPRL SSB 940 may be different from that of the LPRL synchronization signal 842. Therefore, the UE 704 requires this information to correctly receive and process the HPRL SSB 940.
System Frame Number (SFN): The SFN is included in the LPRL broadcast message 920 to help the UE 704 maintain synchronization with the cell 710.

To optimize the bit allocation in the LPRL broadcast message 920, the information carried can be made dependent on the SCI. For example, if the SCI indicates that the base station 702 is in a “sleeping” state (i.e., not transmitting on the high-performance radio layer), the LPRL broadcast message 920 does not need to include information related to the high-performance radio layer, such as the frequency reference, time reference, power offset, and SCS of the HPRL SSB 940. Conversely, if the SCI indicates that the base station 702 is actively transmitting on the high-performance radio layer, the LPRL broadcast message 920 should include this information but can omit the base station wake-up signal relevant information, as the UE 704 does not need to send the wake-up request 930 in this case.

By dynamically adapting the contents of the LPRL broadcast message 920 based on the current state of the base station 702, the low-power radio layer can optimize the use of available bits and reduce unnecessary overhead.

To optimize the number of bits in the LPRL broadcast message 920, the information carried can be made dependent on the sleeping cell indication (SCI). The SCI may be a 1-bit indicator that informs the UE 704 whether the base station 702 is currently transmitting signals or channels on the high-performance radio layer, such as the MIB/SIB 852 or fine synchronization signals.

If the SCI indicates that the high-performance radio layer is in a “sleep state” (i.e., no transmission on the high-performance radio layer), the LPRL broadcast message 920 only needs to include the base station wake-up signal relevant information. This information is necessary for the UE 704 to send the wake-up request 930 to the base station 702, prompting it to start transmitting on the high-performance radio layer.

On the other hand, if the SCI indicates that the high-performance radio layer is “active” (i.e., there are signals being transmitted on the high-performance radio layer), the LPRL broadcast message 920 should include the following information:
Frequency reference of the HPRL SSB 940
Time reference of the HPRL SSB 940
Power offset between the LPRL synchronization signal 842 and the HPRL SSB 940
Subcarrier spacing (SCS) of the HPRL SSB 940
   This information is for the UE 704 to locate, receive, and process the signals and channels transmitted on the high-performance radio layer.

In other words, if the base station 702 is in a “sleeping” state, indicating that it is not actively transmitting high-demand signals such as on-demand reference signals (RS) or the HPRL SSB 940, the LPRL broadcast message 920 need not include information related to the high-performance radio layer. Conversely, if the base station 702 is “awake” and actively transmitting on the HPRL, the LPRL broadcast message 920 will include this information but can omit details about the base station wake-up signal relevant information, as the wake-up request 930 would not be necessary in this scenario. This information includes the frequency reference, time reference, power offset, and Subcarrier Spacing (SCS) of the HPRL SSB 940.

The system information update and ETWS and/or CMAS notification can be carried by either the paging message or the LPRL broadcast message 920, depending on the paging rate and the frequency of information change. For example, if the paging rate is low and the information seldom changes, it is more resource-efficient to carry the information in the paging message. Otherwise, it is better to include the information in the LPRL broadcast message 920.

Considering the characteristics of the information (e.g., some information items are required by the UE 704 in all RRC states, while others are only needed during initial access or cell search), the information can be further divided and carried by two types of common signals/channels:
Common signal/channel type 1: This type of signal/channel is received by the UE 704 during cell search, initial access, RRC idle/inactive, and connected mode. It carries at least one of the following information items:
   Partial or full Cell ID
   Sleeping cell indication (SCI)
   System information update
   ETWS and/or CMAS notification
   System Frame Number (SFN)
Common signal/channel type 2: This type of signal/channel is received by the UE 704 during cell search and initial access. It carries at least one of the following information items:
   Base station wake-up signal relevant information
   Frequency reference of the HPRL SSB 940
   Time reference of the HPRL SSB 940
   Power offset between the LPRL synchronization signal 842 and the HPRL SSB 940
   Subcarrier spacing (SCS) of the HPRL SSB 940

Bit number optimization, as described earlier, is still applicable for common signal/channel type 2. Common signal/channel type 1 and common signal/channel type 2 can be either two different signals/channels or two different codeblocks/segments of the same signal/channel.

By optimizing the contents of the LPRL broadcast message 920 based on the SCI and the characteristics of the information, the low-power radio layer can minimize the number of bits required while ensuring that the UE 704 receives all the necessary information for maintaining a connection with the cell 710 and performing essential operations.

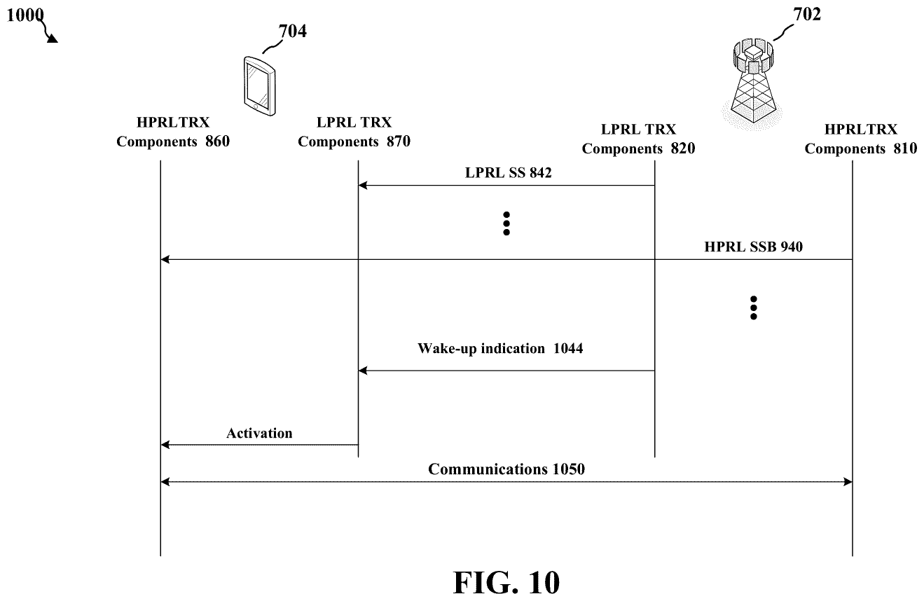

FIG. 10 is a diagram 1000 illustrating communications between the base station 702 and the UE 704 during connected mode. In connected mode, the UE 704 may operate in a power-saving manner, utilizing primarily the LPRL TRX components 870 to monitor signals.

The base station 702 periodically transmits the LPRL synchronization signal 842 to facilitate RRM measurements and maintain the connection with the UE 704. When needed, the base station 702 also transmits the HPRL SSB 940 using the HPRL TRX components 810.

Traditionally, in networks such as NR, wake-up signals were integrated into the control information, necessitating continuous monitoring by the UE 704 and, consequently, higher power consumption. However, with the introduction of the LPRL and its wake-up indication feature, the UE 704 can perform monitoring tasks more sporadically, significantly reducing energy consumption while still maintaining readiness for incoming data or control signals.

As described supra, the UE 704 receives the LPRL synchronization signal 842 from the LPRL TRX components 820 of the base station 702 for Radio Resource Management (RRM) measurements. Additionally, the base station 702 may transmit a signal 1044 containing a wake-up indication.

Upon receiving the wake-up indication, the UE 704 enables its HPRL TRX components 860 to perform UE-specific reference signal (RS) reception, control channel monitoring, and data reception. The HPRL TRX components 860 of the UE 704 remain enabled to continuously perform necessary RS synchronization and receive updated system information, such as the MIB/SIB 852, when available.

The HPRL TRX components 860 of the UE 704 are only active when needed, such as for control channel monitoring or receiving reference signals and system information. During other times, the HPRL TRX components 860 can enter a sleep state to conserve energy.

The LPRL TRX components 870 of the UE 704 guide the HPRL TRX components 860 by indicating the presence of a wake-up indication. Upon receiving the wake-up indication, the HPRL TRX components 860 wake up and perform the corresponding PDCCH monitoring. In the absence of a wake-up indication, the HPRL TRX components 860 do not need to monitor the PDCCH.

After waking up, the UE 704 uses the HPRL TRX components 860 to perform communications 1050 with the HPRL TRX components 810 of the base station 702. In particular, the UE 704 may use the HPRL TRX components 860 to receive UE-specific RSs, monitor control channels, and/or receive data.

The use of the low-power radio layer for wake-up indication in connected mode offers several advantages compared to the previous wake-up signal design in NR, which relied on a single radio frequency component and carried the wake-up information in the downlink control information (DCI).

With the introduction of dual receivers (LPRL TRX components 870 and HPRL TRX components 860) in the UE 704, the wake-up mechanism can be optimized for power consumption and latency. Since the active power of the LPRL TRX components 870 is significantly lower than that of the HPRL TRX components 860, the UE 704 can perform more frequent monitoring on the low-power radio layer, resulting in improved latency compared to the previous design.

Furthermore, the wake-up indication carried by the low-power radio layer can directly control the PDCCH monitoring behavior of the UE 704, without being tied to the DRX mechanism. This allows for a more flexible and efficient power-saving scheme, as the UE 704 can dynamically adapt its PDCCH monitoring based on the presence or absence of the wake-up indication.

For the UE 704 in connected mode, the base station 702 transmits a wake-up indication via the low-power radio layer, denoted as a wake-up signal/channel for convenience. The design of the wake-up indication for connected mode is similar to the paging indication described earlier, with the main difference being that the wake-up indication is used to inform the UE 704 whether it needs to monitor the control channel.

The signal 1044 containing the wake-up indication is using either a sequence-based format or a payload format. When the payload format is used, N CRC bits, where N>1, are attached after the payload to achieve a feasible false alarm rate. The value of N can be chosen based on the desired false alarm rate performance.

The wake-up signal/channel can be UE-specific or group-UE-specific, depending on the traffic situation of the UE 704. This allows for a more targeted and efficient wake-up mechanism, as the base station 702 can adapt the wake-up indication to the specific needs of individual UEs or groups of UEs.

If the wake-up indication instructs the UE 704 to wake up for data scheduling, the UE 704 activates its HPRL TRX components 860 and starts receiving and monitoring downlink reference signals, control channels, and data channels from the high-performance radio layer. This enables the UE 704 to promptly receive any scheduled data or control information.

On the other hand, if the wake-up indication does not instruct the UE 704 to wake up, the UE 704 is not expected to receive any dynamic signals or channels from the high-performance radio layer until the next monitoring occasion of the wake-up signal/channel. This allows the UE 704 to conserve energy by keeping its HPRL TRX components 860 in a low-power state when there is no need to monitor the high-performance radio layer.

The use of the wake-up indication in connected mode provides a flexible and efficient power-saving mechanism for the UE 704. By dynamically controlling the activation of the HPRL TRX components 860 based on the presence or absence of scheduled data or control information, the UE 704 can minimize its energy consumption while maintaining its responsiveness to the network.

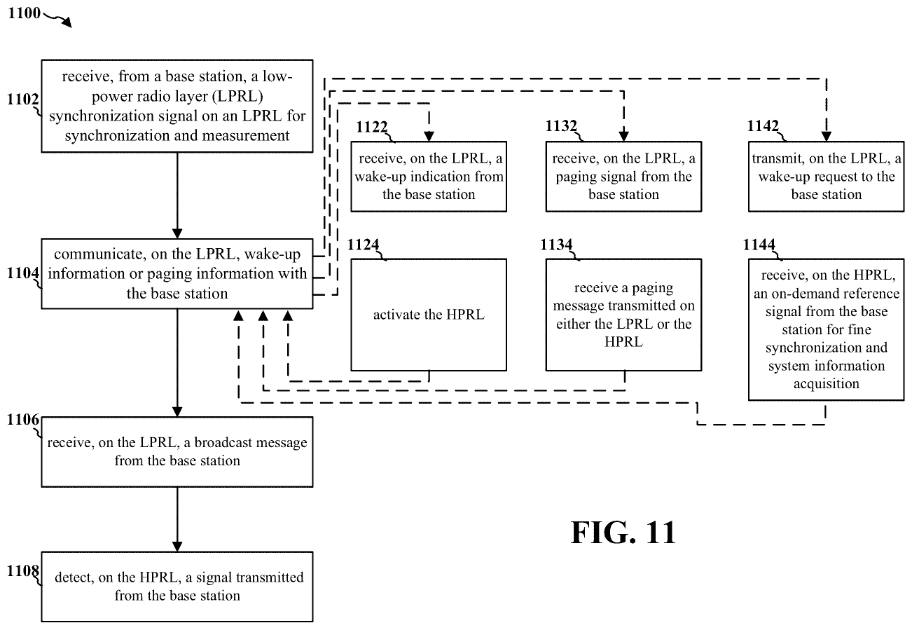

FIG. 11 is a flow chart 1100 of a method for wireless communication utilizing an LPRL and an HPRL. The method may be performed by a UE (e.g., the UE 704). In operation 1102, the UE receives, from a base station, a low-power radio layer (LPRL) synchronization signal on an LPRL for synchronization and measurement. In certain configurations, the LPRL synchronization signal carries at least one of: no information, partial cell ID information, or full cell ID information.

In operation 1104, the UE communicates, on the LPRL, wake-up information or paging information with the base station for subsequent communications on a high-performance radio layer (HPRL).

In certain configurations, when communicating the wake-up information or paging information in operation 1104, the UE receives, on the LPRL, a wake-up indication from the base station in operation 1122. In certain configurations, the UE receives, on the LPRL, the wake-up indication during a connected mode. In operation 1124, the UE activates the HPRL.

In certain configurations, when communicating the wake-up information or paging information in operation 1104, the UE receives, on the LPRL, a paging signal from the base station in operation 1132. The paging signal includes at least one of: paging related information, an indication for system information update, or a notification for Earthquake and Tsunami Warning System (ETWS) or Commercial Mobile Alert System (CMAS).

The paging related information includes at least one of: a wake-up indication for the UE or a group of UEs, or a paging message containing a UE ID. The wake-up indication may be for the UE or the group of UEs.

After receiving the wake-up indication, in operation 1134, the UE further receives the paging message transmitted on either the LPRL or the HPRL. The paging message may include the UE ID. After receiving and detecting or decoding the paging message, in certain configurations, the UE may further perform a random access channel (RACH) procedure for entering a radio resource control (RRC) connected mode.

In certain configurations, the paging message for the UE or the group of UEs is distributed in multiple signals or channels transmitted on different time or frequency resources. The UE receives and detects or decodes the multiple signals or channels to determine whether the UE is paged.

In certain configurations, when communicating the wake-up information or paging information in operation 1104, the UE transmits, on the LPRL, a wake-up request to the base station in operation 1142. In operation 1144, the UE receives, on the HPRL, an on-demand reference signal from the base station for fine synchronization and system information acquisition.

Subsequent to operation 1104, in operation 1106, the UE receives, on the LPRL, a broadcast message from the base station. The broadcast message includes at least one of: partial or full cell ID information, a sleeping cell indication, a system information update, an Earthquake and Tsunami Warning System (ETWS) or Commercial Mobile Alert System (CMAS) notification, wake-up signal relevant information, a frequency reference of at least one of an HPRL synchronization signal block (SSB) and a Physical Broadcast Channel (PBCH), a time reference of the HPRL SSB, a power offset between the LPRL synchronization signal and the HPRL SSB, a subcarrier spacing of the HPRL SSB, and a system frame number.

In certain configurations, contents of the broadcast message are dependent on the sleeping cell indication. The broadcast message includes the wake-up signal relevant information when the sleeping cell indication indicates that the HPRL is in a sleep state. The broadcast message includes an HPRL synchronization signal block (SSB) when the sleeping cell indication indicates that the HPRL is in an active state.

In operation 1108, the UE detects, on the HPRL, a signal transmitted from the base station. In certain configurations, the signal detected on the HPRL includes system information. In certain configurations, to detect, on the HPRL, the signal transmitted from the base station, the UE monitors, on the HPRL, a downlink control channel or receives downlink data from the base station.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a user equipment (UE), comprising:
receiving, from a base station, a low-power radio layer (LPRL) synchronization signal on an LPRL for synchronization and measurement;
communicating, on the LPRL, wake-up information or paging information with the base station for subsequent communications on a high-performance radio layer (HPRL); and
detecting, on the HPRL, a signal transmitted from the base station.

2. The method of claim 1, wherein the communicating the wake-up information or paging information includes receiving, on the LPRL, a wake-up indication from the base station, wherein the signal detected on the HPRL includes system information, the method further comprising:
subsequent to receiving the wake-up indication and prior to detecting the signal on the HPRL, activating the HPRL.

3. The method of claim 1, wherein the communicating the wake-up information or paging information includes receiving, on the LPRL, a paging signal from the base station, wherein the paging signal including at least one of: paging related information, an indication for system information update, or a notification for Earthquake and Tsunami Warning System (ETWS) or Commercial Mobile Alert System (CMAS).

4. The method of claim 3, wherein the paging related information includes at least one of: a wake-up indication for the UE or a group of UEs, or a paging message containing a UE ID.

5. The method of claim 4, wherein the wake-up indication is for the UE or the group of UEs, and wherein after receiving the wake-up indication, the UE further receives the paging message transmitted on either the LPRL or the HPRL.

6. The method of claim 4, wherein the paging message includes the UE ID, and wherein after receiving and detecting or decoding the paging message, the UE further performs a random access channel (RACH) procedure for entering a radio resource control (RRC) connected mode.

7. The method of claim 6, wherein the paging message for the UE or the group of UEs is distributed in multiple signals or channels transmitted on different time or frequency resources, and wherein the UE receives and detects or decodes the multiple signals or channels to determine whether the UE is paged.

8. The method of claim 1, wherein the LPRL synchronization signal carries at least one of: no information, partial cell ID information, or full cell ID information.

9. The method of claim 1, further comprising:
receiving, on the LPRL, a broadcast message from the base station, the broadcast message including at least one of: partial or full cell ID information, a sleeping cell indication, a system information update, an Earthquake and Tsunami Warning System (ETWS) or Commercial Mobile Alert System (CMAS) notification, wake-up signal relevant information, a frequency reference of at least one of an HPRL synchronization signal block (SSB) and a Physical Broadcast Channel (PBCH), a time reference of the HPRL SSB, a power offset between the LPRL synchronization signal and the HPRL SSB, a subcarrier spacing of the HPRL SSB, and a system frame number.

10. The method of claim 9, wherein contents of the broadcast message are dependent on the sleeping cell indication, and wherein the broadcast message includes the wake-up signal relevant information when the sleeping cell indication indicates that the HPRL is in a sleep state.

11. The method of claim 9, wherein contents of the broadcast message are dependent on the sleeping cell indication, and wherein the broadcast message includes an HPRL synchronization signal block (SSB) when the sleeping cell indication indicates that the HPRL is in an active state.

12. The method of claim 1, wherein the communicating the wake-up information or paging information includes transmitting, on the LPRL, a wake-up request to the base station, wherein the method further comprises:
receiving, on the HPRL, an on-demand reference signal from the base station for fine synchronization and system information acquisition.

13. The method of claim 1, wherein the communicating the wake-up information or paging information includes receiving, on the LPRL, a wake-up indication from the base station during a connected mode; and
wherein detecting, on the HPRL, the signal transmitted from the base station includes monitoring, on the HPRL, a downlink control channel or receiving downlink data from the base station.

14. An apparatus for wireless communication, the apparatus being a user equipment (UE), comprising:
a memory; and
at least one processor coupled to the memory and configured to:
receive, from a base station, a low-power radio layer (LPRL) synchronization signal on an LPRL for synchronization and measurement;
communicate, on the LPRL, wake-up information or paging information with the base station for subsequent communications on a high-performance radio layer (HPRL); and
detect, on the HPRL, a signal transmitted from the base station.

15. The apparatus of claim 14, wherein to communicate the wake-up information or paging information, the at least one processor is configured to receive, on the LPRL, a wake-up indication from the base station, wherein the signal detected on the HPRL includes system information, and wherein the at least one processor is further configured to:
subsequent to receiving the wake-up indication and prior to detecting the signal on the HPRL, activate the HPRL.

16. The apparatus of claim 14, wherein to communicate the wake-up information or paging information, the at least one processor is configured to receive, on the LPRL, a paging signal from the base station, wherein the paging signal includes at least one of: paging related information, an indication for system information update, or a notification for Earthquake and Tsunami Warning System (ETWS) or Commercial Mobile Alert System (CMAS).

17. The apparatus of claim 16, wherein the paging related information includes at least one of: a wake-up indication for the UE or a group of UEs, or a paging message containing a UE ID.

18. The apparatus of claim 17, wherein the wake-up indication is for the UE or the group of UEs, and wherein after receiving the wake-up indication, the at least one processor is further configured to receive the paging message transmitted on either the LPRL or the HPRL.

19. The apparatus of claim 14, wherein the at least one processor is further configured to receive, on the LPRL, a broadcast message from the base station, the broadcast message including at least one of:
partial or full cell ID information, a sleeping cell indication, a system information update, an Earthquake and Tsunami Warning System (ETWS) or Commercial Mobile Alert System (CMAS) notification, wake-up signal relevant information, a frequency reference of at least one of an HPRL synchronization signal block (SSB) and a Physical Broadcast Channel (PBCH), a time reference of the HPRL SSB, a power offset between the LPRL synchronization signal and the HPRL SSB, a subcarrier spacing of the HPRL SSB, and a system frame number.

20. A computer-readable medium storing computer executable code for wireless communication of a user equipment (UE), comprising code to:
receive, from a base station, a low-power radio layer (LPRL) synchronization signal on an LPRL for synchronization and measurement;
communicate, on the LPRL, wake-up information or paging information with the base station for subsequent communications on a high-performance radio layer (HPRL); and
detect, on the HPRL, a signal transmitted from the base station.
